(19) United States
(12) Patent Application Publication
(10) Pub. No.: US 2003/0077515 A1
(43) Pub. Date: Apr. 24, 2003

(54) Conducting polymer-carbon nanotube composite materials and their uses

(76) Inventors: George Zheng Chen, Cambridge (GB); Derek John Fray, Cambridge (GB); Mark Hughes, Cambridge (GB); Milo Sebastian Peter Shaffer, Cambridge (GB); Alan H. Windle, Cambridge (GB)

Correspondence Address: PILLSBURY WINTHROP, LLP, P.O. BOX 10500, MCLEAN, VA, 22102, US

(21) Appl. No.: 09/822,831

(22) Filed: Apr. 2, 2001

(51) Int. Cl. H01M 4/58; H01M 4/60

(52) U.S. Cl. 429/231.8; 252/511; 429/213; 524/847

(57) ABSTRACT

Electronically conductive composites of electronically conductive polymers and carbon nanotubes are formed by electrochemical or gel polymerisation of monomer in a carbon nanotube suspension. Electrical energy storage devices are produced from carbon nanotube/electronically conductive polymer composites.

### FIELD OF THE INVENTION

This invention concerns electronically conductive polymer/carbon nanotube composites, their production and their use in energy storage devices such as supercapacitors and secondary batteries.

### BACKGROUND OF THE INVENTION

The remarkable mechanical and electrical properties exhibited by carbon nanotubes have encouraged efforts to develop mass production techniques. As a result, carbon nanotubes are becoming increasingly available, and more attention from both academia and industry is focused on the applications of carbon nanotubes in bulk quantities. These opportunities include the use of carbon nanotubes as a conductive filler material in insulating polymer matrices, and as reinforcement in structural materials. Other potential applications exploit the size of carbon nanotubes as a template to grow nano-sized, and hence ultra-high surface-to-volume ratio catalysts, or aim to combine carbon nanotubes to form nano-electronic elements.

On the other hand, electronically conducting polymers (ECPS) have been the focus of many intensive research programmes in the past two decades. Simple conducting polymers, typically polypyrrole, polyaniline and polythiophene, can be prepared either chemically in a bulk quantity, or electronchemically as a thin film. In addition to a relatively high conductivity in the doped state, simple conducting polymers show interesting physicochemical properties exploitable for batteries, sensors, light-emitting diodes and electrochromic displays. Furthermore, there are two opportunities that allow the functionality of simple conducting polymers to be extended. Firstly, large anions with particular functions, such as natural enzymes or catalytic transition metal complexes can be used as the counter anion/dopant and therefore be entrapped within the ECP matrix during the polymerisation process. Secondly, the monomers of conventional conducting polymers can be functionalised to form sensory devices aimed at molecular recognition.

However, the use of both carbon nanotubes and conducting polymers in many applications presents significant challenges. For example, the high cost and low production volume of carbon nanotubes is at present prohibitively high for them to be used as a filler material in most large-scale structural and electrical applications. In the specific case of the use of carbon nanotubes as nanoelectronic elements, one of the difficult tasks will be to attach them to each other and to an external electronic framework. On the other hand, all known simple conducting polymers are mechanically weak and have to be oxidised and doped by a counter anion to achieve significant conductivity. The strength of a conducting polymer may be improved by, for example, co-polymerization with a second polymer such as PVC but a sacrifice in conductivity is inevitable. In addition, because dopants constitute a large proportion of conducting polymers, typically 20-40 vol %, and all the dopants used so far are themselves insulators, the overall conductivity of conducting polymers is somewhat limited. Retardant effects of some inorganic dopants on the optical properties of conducting polymers have also been reported. Furthermore, in a practical application in a reducing environment, a conducting polymer material with a non-conductive dopant may lose its conductivity altogether.

Whilst electronically conductive polymers such as polypyrrole may be prepared by electropolymerisation in the form of conductive films (U.S. Pat. Nos. 3,574,072 and 4,468,291) by oxidation of pyrrole at an anode, chemical free radical plymerisation of pyrrole produces a powder product (U.S. Pat. No. 4,697,000).

Two recent short communications reported composites of carbon nanotubes and conducting polymers. In the first case, polypyrrole was prepared via the chemical oxidation of pyrrole in the presence of carbon nanotubes and the product was a powder. In the second case, polyaniline was grown into a thin layer of whiskers of straight carbon nanotubes that were glued to the surface of a platinum wire. (Fan et al; Downs et al).

Neither of these methods is suitable for the production of electronically conductive polymer/nanotube compositions as a unitary or unified polymer mass without stringent restrictions on the size of the mass of material produced.

There is a need for energy sources that are optimised to provide electrical energy at high power levels for short times. Since these devices far exceed the power capabilities of conventional capacitors, they are referred co as super-capacitors. Typical uses include very short pulse applications such as digital electronic devices (Huggins et al), longer power pulse devices such as heart defibrillators (Fricke et al), as well as much longer transient power applications including electric vehicles and load levelling in power plants (Faggioli et al).

One such energy source, the double-layer supercapacitor, utilises the electrical double-layer found at the electrolyte-electrode interface in an electrochemical cell (Mayer et al). The amount of charge that can be stored is of the order of 15-40 μF cm⁻² and is optimised by maximising the area of the electrolyte/electrode interface (Conway (1) and Conway (2)). Various techniques have been devised to produce high surface area, chemically inert electrode materials, with those based on high area carbons such as activated carbon and carbon nanotubes showing some of the most promising results (Liu et al).

More recently, it has been found that materials such as conducting polymers and ruthenium oxide can be reversibly oxidised and reduced, referred to as a charging-discharging cycle, by appropriate potentials when they are used as electrodes in an electrochemical cell (Kalaji et al, Long et al). This property alone makes these materials suitable for use in secondary batteries. However, the current response of these materials to the applied potential is similar to that of a capacitor, making them also suitable for use as supercapacitors. Since the charging-discharging cycle for these materials involves a chemical reaction this phenomenon is referred to as pseudo-capacitance. When electron transfer occurs during oxidation and reduction, neutrality of the material is maintained by exchanging ionic species with the adjoining electrolyte (Sarangapani et al). Unlike double-layer layer capacitors where charge accumulation is confined to the interfacial region, pseudo-capacitive materials score charge on a molecular level in three-dimensional space, and hence exhibit much greater levels of capacitance (Zheng et al).

In recent times, many thin-film double-layer capacitors and pseudo-capacitors have been developed. Specific capacitances per unit mass (Cₘₐₛₛ) and per unit geometric area (Cₐᵣₑₐ) as high as 140 Fg⁻¹ and 173 mF cm⁻², respectively, have been achieved using double-layer capacitors (Sawai et al, Niu et al). Alternatively, values approaching 750 Fg⁻¹ and 250 mF cm⁻², respectively, have been observed for pseudo-capacitive materials (Fusalba et al; Carlberg et al; Cimino et al).

Ideally, the total capacitance of the material should increase with the total quantity of the material and hence the film thickness. However, previous work has shown that the accessibility of the capacitance decreases rapidly with increasing film thickness. For example, the application of conducting polymers in batteries revealed that specific charges as high as 250 A h kg⁻¹ (equivalent to 900 Fg⁻¹ at 1V) were attained in thin films (Otero et al). However, when the thickness was increased to facilitate employment in meaningful applications, the specific charge fell to 50-70 A h kg⁻¹. This difficulty can be attributed to the slow transfer of either or both electrons and ions in the film.

Novel composites combining redox (polypyrrole, polyaniline and ruthenium oxide) and double-layer (carbon fibres, activated carbon black and carbon nanotubes) materials have been reported (Curran at al; Fan J. H.; Wan M. W. et al; Yoshino et al). In particular, as described above, polyaniline has been grown into a thin layer of whiskers of straight carbon nanotubes that were glued to the surface of a platinum wire (Downs et al). The value of Cₐᵣₑₐ for the obtained composite electrode was about 241 mF/cm² as estimated from cyclic voltammograms. Electron microscopy revealed that the composite film was highly porous with individual nanotubes being coated by a very thin layer (up to 10² nm) of the polymer. In our view, this morphology favours a faster ionic charge transfer, which is beneficial to increasing the power density of a capacitor. However, although not impossible, it would be difficult to promote polymerization on the surfaces of individual nanotubes inside the film without covering up the external surface of the film and hence blocking the openings of the electrolyte channels is in the original framework of carbon nanotubes.

### BRIEF SUMMARY OF THE INVENTION

The present invention provides a method for the production of an electronically conducting polymer composite material comprising preparing a dispersion or carbon nanotubes in a solution of one or more polymerisable monomers which upon polymerisation form an electronically conductive polymer, and polymerising the monomer solution to form a unitary polymer mass containing said nanotubes dispersed therein.

Two methods of producing the polymerisation are described herein for use in this first aspect of the invention. The first is electropolymerisation and the second is slow chemical oxidation to produce a gel.

The suspension may be electropolymerised in a manner generally known for the electropolymerisation of electronically polymerisable monomers that produce electronically conductive polymers.

Electronically conductive polymers are a class of electrically conductive polymers that excludes polymers which conduct by ionic conduction, e.g. Nafion films. Electronically conductive polymers conduct by electron flow and fall into two categories according to their conduction mechanism. A first category consists of polymers that are π conjugated and conduct by limited or complete delocalisation along the polymer chain. The second category conducts by electron hopping along redox centres closely located on each polymer chain, as in polyvinyl ferrocene.

Monomers for polymerisation to form π-conjugated electronically conductive polymers include aniline, benzene, furan, pyrrole, thiophene and their derivatives. Preferred monomers includes those of the formula:

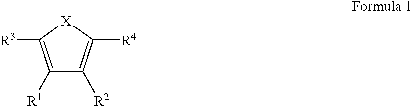

where each of R¹ and R² independently may be H, alkyl (especially C₁ to C₁₀, more preferably C₁ to C₅ alkyl), halogen (especially Br, Cl or I), alkoxyalkyl (especially C₁ to C₁₀ alkoxy C₁ to C₁₀ alkyl) , alkoxy polyether, or alkylene polyether. The polyether may in each case be a crown ether. X may be NR⁵, S or O where R⁵ may be of the same nature as given for R¹ and R² and in particular may be alkyl (especially as given for R) or aryl (especially phenyl) or aralkyl (especially benzyl) or substituted aralkyl.

R³ and R⁴ independently may be H or polymerisable substituents.

Polymerisable substituents include the compounds given above as monomers, so that examples of suitable monomers of this kind include:

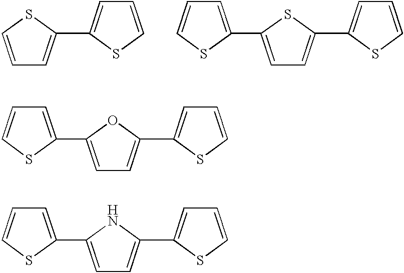

where R³ and R⁴ are thiophene, and where one heterocycle is substituted at the 2- and or 5-position with another, the heteroatoms may be the same or different.

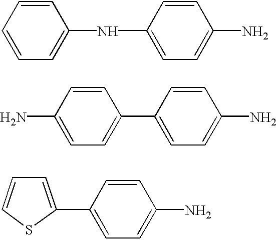

where R⁵ is thiophere or aniline bonded via NH— or via the 4-position carbon.

Examples of polymerisable monomers are to be found in Ryder et al, Audebert et al and Schweiger at al.

Examples of suitable monomers include

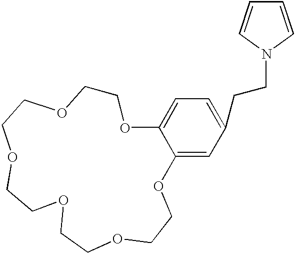

Preferred compounds according to the above Formula 1 include those which are disubstituted at the 3,4 positions, including 3,4 -dimethyl pyrrole, 3,4-diethyl pyrrole and 3,4-dihalopyrroles such as dichloropyrrole.

Alternatively, the monomer may be of the formula:

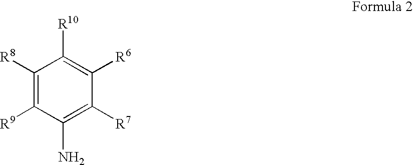

where R⁶, R⁷, R⁸ and R⁹ independently are as given above for R¹/R² and R¹⁰ is given above for R³/⁴.

Heterocyclic monomers for polymerisation in the invention may contain 5-membered rings and may, if so desired, contain substituents consistent with being polymerisable. These substituents may be selected from the group consisting of halogen, aromatic alkyl, of from 1 to 10 carbon atoms, cycloalkyl, alkaryl, aralkyl, alkoxy, acyl, etc. radicals. Some specific examples of these heterocyclic compounds which may be used include furan, thiophene, pyrrole, 3-methylfuran, 3-ethylfuran, 3-n-butylfuran, 3-decylfuran, 3,4-thia-n-propylfuran, 3,4-didodecylfuran, 3-bromofuran, 3,4-dichlorfuran, 3,4-difurylfuran, 3-benzylfuran, 3-cyclohexylfuran, 3-methoxyfuran, 3,4-dipropoxyfuran, 3-[4-trimethylaminophenyl]-thiophene 3-methyl-thiophene, 3-ethyl-thiophene, 3-n-butyl-thiophene, 3-decyl-thiophene, 3,4-di-n-propylthiophene, 3,4-didodecyl-thiophene, 3-bromothiophene, 3,4-dichloro-thiophene, 3,4-furylthiophene, 3-benzylthiophene, 3-cyclohexyl-thiophene, 3-methoxy-thiophene, 3,4-dipropoxythiophene, 3-methylpyrrole, 3-ethyl-pyrrole, 3-n-butylpyrrole, 3-decylpyrrole, 3,4-di-n-propylpyrrole, 3,4-didodecyl-pyrrole, 3-bromopyrrole, 3,4-dichloro-pyrrole, 3,4-difurylpyrrole, 3-cyclo-hexylpyrrole, 3-methoxypyrrole and 3,4-dipropoxypyrrole.

It is to be understood that the aforementioned heterocyclic compounds are only representative, and that the present invention is not limited thereto.

In addition the heterocycles discussed above anilines and substituted anilines may be used. A substituted aniline useful in the invention is 1,5-diaminoanthroquinone having a moiety of 1,4-benzoquinone condensed between two moieties of aniline (Naoi et al). This forms an electron hopping type electronically conductive polymer when reduced. A further substituted aniline suitable for use in the invention is 2,2′-dithiodianiline (Nani et al).

Other monomers for forming redox active polymers include vinyl ferrocene and Ru(4-methyl-4′-vinylbipyridine).

Some of these redox active polymers can be electropolymerised, e.g. poly[Ru(4-methyl-4′-vinylbipyridine)₃]²⁺, but some cannot, e.g. poly-(vinylferrocene) which, however, can be prepared by a chemical method such as the gel method.

Suitable comonomers include acetylene and polynuclear aromatics comonomers which are suitable for use together with the pyrroles in the novel process, in addition to alkynes, e.g. acetylene, and polynuclear aromatics, e.g. the oligophenylenes, acenaphthene, phenanthrene and tetracene, are, in particular, other 5-membered and/or 6-membered heterocyclic aromatic compounds. These other heteroaromatic compounds preferably contain from 1 to 3 hetero atoms in the ring system, may be substituted at the hetero atoms or at the ring carbon atoms, for example by alkyl groups, in particular of 1 to 6 carbon atoms, and preferably possess two or more unsubstituted ring carbon atoms so that the anodic oxidation can be simply and readily carried out. Examples of hetero-aromatic compounds which are very useful comonomers and which can be used either alone or mixed with one another are furan, thiophene, thiazole, oxazole, thiadiazole, imidazole, pyridine, 3,5-dimethylpyridine, pyrazine and 3,5-dimethyl-pyrazine. Comonomers which have proved to be particularly useful are the 5-membered heteroaromatic compounds, such as furan, thiophene, thiazole and thiadiazole. If, in the novel process, pyrroles are employed together with other comonomers, the weight ratio of the pyrroles to the other comonomers can very within wide limits, for example from 1:99 to 99:1. Preferably, such comonomer mixtures contain from 20 to 90% by weight of the pyrroles and from 80 to 10% by weight of the other comonomers, the percentages in each case being based on the sum of the pyrroles and the other comonomers.

The monomers and comonomers described above may also be employed in the non-electrochemical polymerisation process described herein.

The electrochemical polymerisation may be conducted either in aqueous solution or using non-aqueous solvents. When working in aqueous solution, the maximum concentration of the monomer may be limited by solubility. The minimum concentration of the monomer will generally be dependent on the quantity needed to produce a polymer under the conditions in a reasonable period. A general working range may be from 0.01M to 5M, but especially the upper limit of this range will not be achievable with all monomers, because of solubility constraints. A preferred range is from 0.1M to 0.5M, which is a suitable range for instance for pyrrole in water. Generally, lower concentrations of monomer produce a more compact and flexible film and higher concentrations produce a more porous film.

The concentration of carbon nanotubes in the suspension may be limited by their ability to form a continuous current path between the anode and the cathode during electrochemical polymerisation, thus effectively shorting out internally the electrochemical cell used. The concentration at which this happens will generally be lower for longer nanotubes than for shorter ones. At the lower end of the scale, the concentration used is limited only by the concentration of nanotubes desired in the product. Generally, a working range of nanotube concentration in the suspension may be from 0.0001 to 1 wt %, e.g. from 0.001 to 1 wt %.

In the electrochemical method of making conducting polymer-carbon nanotube composite films of the first aspect of the invention, the carbon nanotubes are suspended within the electrolyte either naturally or dynamically (e.g. via intermittent or continuous mixing or ultra-sonication). The carbon nanotubes may or may not have been pre-treated to functionalise their surface. For example, the partial oxidation of carbon nanotubes in an aqueous oxidising acidic medium can lead to the formation of oxygenated surface groups. These surface groups can be ionised or negatively charged via de-protonation in an aqueous solution or other solutions having an affinity for protons.

The carbon nanotubes may be single or multiwalled, straight, curved or coiled and may be interconnected or not interconnected. They may be completely or partially coated by the electronically conductive polymer and may be randomly oriented with respect to one another or aligned to a greater or lesser degree.

The electrolyte itself typically consists of a pure solvent (for negatively charge nanotubes) or electrolyte solution (for nanotubes without surface modifications), combined with a monomer or monomers. The solvent of the electrolyte may be water or may be a non-aqueous solvent or a mixture of aqueous and non-aqueous solvents. Polar organic solvents are preferred as non-aqueous solvents. Examples of solvents which may be used include the alcohols such as methanol, ethanol, n-propanol, isopropanol, n-butanol, t-butanol, n-pentanol, n-hexanol, n-heptanol, n-octanol and isomers thereof, etc.; carboxylic acids such as formic acid, acetic acid, propionic acid, butyric acid, valeric acid, etc.; glycols such as ethyl glycol, dethylene glycol, propylene glycol, etc.; ketones such as acetone; acetonitrile; dimethyl sulfoxide; dimethyl formamide, tetrahydrofuran, propylene carbonate; dioxane; ethers such as dimethyl ether, diethyl ether, dipropyl ether, dibutyl ether, dichloromethane, toluene, etc. Ionic liquids (room temperature molten salts) such as mixed aluminium chloride and butylpyridinium chloride, 1-butyl-3-methyl imidazolium tetrafluoroborate/hexafluoraphosphate may be used. The solvent may be a liquid of the monomer or mixed monomer and/or co-monomers described above.

Other than water, suitable electrolyte solvents for the novel process include the polar organic solvents which are conventionally employed for the electrochemical polymerisation of pyrroles and are capable of dissolving the monomers and the conductive salt. Where a water-miscible organic solvent is need, the electrical conductivity can be increased by adding a small amount of water, in general not more than 10% by weight, based on the organic solvent. Polar solents listed above may be used. Examples of preferred organic electrolyte solvents are alcohols, ethers, such as 1,2-dimethoxyethane, dioxane, tetrahydrofuran and methyltetrahydrofuran, acetonc, acetonitrile, dimethylforamide, dimethylsulfoxide, methylene chloride, N-methlpyrrolidone and propylene carbonate, as well as mixtures of these solvents; further solvents are polyglycols which are derived from ethylene glycol propylene glycol or tetrahydrofuran, e.g. polyethylene glycol, polypropylene glycol, polybutylene glycol or ethylene oxide/propylene oxide copolymers; preferably, these polyglycols possess blocked terminal groups and are hence present as complete polyethers. However, the process can also be carried out in an aqueous electrolyte system, as described in, for example, U.S. Pat. No. 3,574,072.

In cases where the nanotubes are not oxidised, and therefore not negatively charged, a salt or salts must be used as the electrolyte (MₐX_{b}) to be dissolved in the solvent for the electrochemical polymerisation.

X (anions) may be

a) inorganic anions such as X⁻/XO₄⁻/XO₃⁻ (X═Cl, Br, I), HCO₃⁻, CO₃²⁻, NO₃⁻/NO₂⁻, HSO₄⁻/SO₄²⁻, H₂PO₄⁻/HPO₄²⁻/PO₄³⁻, PF₆⁻, BF₄⁻, fullerite (e.g. C₆₀ⁿ⁻/C₇₀ⁿ⁻, n≈1, 2, . . . 6), simple metal complex (e.g. ZnCl₄²⁻, PtCl₆²⁻/PtCl₄²⁻, Ni (CN)₄²⁻, Fe(CN)₆⁴⁻, Pt(CN)₄²⁻), TiO₃²⁻, Cr₂O₄³⁻, MnO₄⁻ and etc.

b) organic/polymeric anions such as R′ (COO⁻)ₙ, R′ (SO₃⁻)ₙ, R′ (PO₃²⁻)ₙ (n=1, 2 . . . n, R′=acyclic or aromatic hydrocarbon group)

c) biological anions such as deprotonated ATP, DNAs, amino-acids, proteins, enzymes

d) non-stoichiometric anions such as anionised carbon nanotubes and particles, poly-metal-oxide based colloidal clusters.

M can be metal ions such as Li⁺, Na⁺, K⁺, Mg²⁺, Ca²⁺, Sr²⁺, Ba²⁺, Cu²⁺/Cu⁺, Ag⁺, Zn²⁺, Al³⁺, Fe³⁺/Fe²⁺ and their complexes with an ionophore (e.g. crown ethers and calixarenes) or H⁺, or R′(NH₃⁺)ₙ.

Electrochemical polymerisation leads to the formation of a thin film (thickness: 10⁻⁸-10⁻² m) either on the surface of a solid substrate (electrode), at the interface between two liquid phases, or between a liquid and a semi-solid phase. The carbon nanotubes are electrostatically and/or physically entrapped in the film. Especially after longer polymerisation times, the film as initially formed may be gelatinous, containing a substantial volume of solvent. This may be removed by drying, leading to shrinkage of the film to the thicknesses referred to above.

The electrochemical polymerisation may be conducted multiple times to build up layers of polymer. In such layers, the polymer used and the carbon nanotubes may be the same as or different from those in other layers.

Gel formation may be obtained merely by keeping a suspension of nanotubes in a solution of suitable monomer for a sufficient period to allow gel formation to occur. The reaction is preferably allowed to proceed at room temperature, but a suitable range of reaction temperatures would be from 10° C. to 50° C. The nanotubes should be anionic so as to remain in suspension during gel formation. Treatments for rendering carbon nanotubes anionic are described above. The admission of controlled amounts of oxygen may speed up the reaction process.

The invention includes electronically conducting polymer composites made by methods according to the invention as described above.

In a second aspect of the invention, the electrochemically polymerized or gelled materials described above or similar materials made by other methods may be used in electrical energy storage devices. Thus, the invention includes an electrical energy storage device, comprising:

a first electrode comprising a first composite of carbon nanotubes and a first electronically conducting polymer which composite has preferably been formed by a method described above in connection with the first aspect of the invention, and a first conducting member in contact with the first composite;

a second electrode; and

an electrolyte comprising mobile cations and anions, the electrolyte separating the first and second electrodes and being in contact with the first composite.

The second electrode may comprise a second composite of carbon nanotubes and a second electronically conducting polymer also preferably made as described above in connection with the first aspect of the invention, and a second conducting member in contact with the second composite; and the electrolyte is in contact with the second composite. The second electronically conducting polymer may of course be the same as or different from the first said polymer.

For use in such an electrical energy storage device, the electrically conducting polymer may be selected independently from those discussed above, especially from polymers or copolymers of aniline, benzene, furan, pyrrole, thiophene and their derivatives, e.g. 3-methylthiophene.

The carbon nanotubes tray be either non-ionised or negatively ionised carbon nanotubes as described above.

The electrolyte in the device may be a solvent and a dissolved salt, it may be an ionic liquid, or it may be a soft solid (ion exchange polymer) or solid electrolyte containing mobile ions. Generally, it may be as described above for use in electrochemical polymerisation. It may be a solution having a concentration from 0.1 M to saturated.

The first and second composites may each be in the form of thin films (optionally comprising more than one layer) on the first and second conducting members respectively. To form a secondary battery or super-capacitator the structure described may be rolled into a cylindrical shape with an insulating spacer between the first and second conducting members.

Preferably, one of the first and second composites comprises a conductive polymer which has a positive redox potential and is oxidisable in charging the device and which upon oxidation acquires a positive charge which is neutralised by the inflow to the polymer of mobile anions from the electrolyte (n-doping) whilst the other of said first and second composites has a negative redox potential and is reducible in charging the device and in being reduced acquires a negative charge which is neutralised by the inflow to the polymer of mobile cations from the electrolyte (p-doping). This use of a cationic polymer for one composite and an anionic polymer for the other composite increases the charge density that the device will support. This requires the use of one p-doped and one n-doped polymer. Polypyrrole and polyaniline cannot n-dope since their n-doping potential is much lower than the reduction potential of common electrolyte solutions. Polythiophene and its derivatives are both n- and p-dopable. Especially for use in the second aspect of the invention, it is preferred that in the or each of the first and second composites, the nanotubes have a length of not less than 1 μm, preferably not less than 5 μm, for instance from 10 to 20 μm or longer, e.g. up to 100 μm. Preferably also, the nanotubes are shaped to promote entanglement. Curved nanotubes are advantageous from this point of view. Both of these factors tend to promote the formation of a highly porous structure, providing superior supercapacitor properties. From this point of view, it is also desirable to have a low content of amorphous carbon or spherical particles amongst the nanotubes, which tend to fill the porous structure. The presence of these materials is greatly decreased by the oxidation process described above for the generation of anionic nanotubes. It is further found that when both nanotubes and small particles are present in the suspension being polymerised, the nanotubes are preferentially taken up in the polymer film as it forms if in order to pre-orientate the nanotubes in the suspension, a powerful AC electric field is applied externally of the electrolysis cell. For instance, a 600 V/cm, 5 KHz field applied between electrodes outside the electrolysis cell is found to promote the exclusion of small particles from the composite formed.

These steps all lead to composites which for use in energy storage devices are superior to those we previously described (Chen et al). There the nanotubes were short (<10 μm) and the resulting films were relatively dense and lacking in porosity and hence less than ideal for these purposes.

The thickness of the first and second composites in an energy storage device is preferably at least 1 μm, e.g. from 1 to 50 μm, more preferably from 5 to 50 μm. Thicker films of the composites will generally speaking support a greater stored charge.

The composite materials may be supported on electrically conductive members. These may be electrodes on which the polymer composites were formed by electrochemical polymerisation. Such supporting conductors may be of many different materials including gold, platinum, graphite, titanium, stainless steel, nickel, carbon, metal alloys and intermetallic compounds (e.g. Ti₆V₄Al, AlNi₃), conducting polymers (as described herein), conducting ceramics (e.g. WO₃ and TiOₓ 0<x<2, Cr₂O₃) and other solid, semi-solid and liquid materials that are electronically conducting and stable in the electrochemical solutions.

They may take the forms of thin foils, perforated foils, meshes, wires, porous solid or semi-solid mass, films on conductive or non-conductive substrates. As described in U.S. Pat. No. 4,468,291 in connection with electronically conducting polymers, the composites may be formed continuously on such materials by passage through a bath containing the suspension of carbon nanotubes in monomer solution, with a suitable voltage being applied to the foil or other material whilst it is in the bath.

Whilst the first and if present the second electronically conductive polymer are preferably produced from a dispersion containing carbon nanotubes suspended in a solution of the appropriate monomer, either by electrochemical polymerisation or non-electrochemical gel formation, other methods of forming electronically conducting polymer/carbon nanotube composites for use in the second aspect of the invention are included.

One may for instance grow a film of electronically is conducting polymer on an aligned carbon nanotube (CNT) preform. That is, a mat of aligned CNTs is prepared prior to polymerisation using a pyrolytic CNT growth technique. This mat is then electrolytically coated with polypyrrole or other conducting polymer using essentially the same electrolysis techniques described herein in relation to carbon nanotube suspensions.

This method has some advantages over the use of a suspension of carbon nanotubes, namely:

1) A high conductivity path back to the electrode despite a thicker film—due to the lack of nanotube-nanotube junctions,

2) a good ion diffusion path through the thickness of the film, due to the lack of tortuosity (the relative size of the diffusion channel may also be readily controlled for optimum performance)

3) a well-defined, uniform and flat electrode due to the uniformity of the nanotube array

4) An ability to vary the active polymer layer thickness and the nanotube array framework independently.

Thicker composite films may be built up by conducting a first such electrochemical polymerisation, drying the polymer film, and then repeating the polymerisation and drying process one or more times. One may use the same or a different monomer in each polymerization stage, thus allowing adjustment of the potential window (the range or potentials in which the film possesses the required redox and capacitive properties) of the multi-component film can be wider than a single component film and therefore allow better performance of, for example, a supercapacitor. By way of example, one is might provide layers of three different nanotube-polymer layers, for example, CNT-PPy/CNT-P3Th/CNT-PAn>(where CNT stands for carbon nanotubes, PPy polypyrrole, P3Th poly-3-methylthiophene, and PAn polyaniline).

A similar layered result can also be achieved however by selection of CNT suspensions containing different monomers and the repetition of electro-polymerisation of such suspensions with drying of the deposited film between monomer changes.

Suitably, the nanotubes used may have a length of 1 to 50 μm or longer. The thickness of the polymer layer produced over a mat of aligned nanotubes by a single electrolysis stage will generally be only a few 10's of nanometres but repeated polymerisation steps can produce films of over 100 μm.

Drying of the film between polymerisations may be conducted in air or in vacuum.

Both aspects of the invention will be further described and illustrated with reference to the following examples which are provided only for illustration and do not limit the scope of the invention. Reference is also made to the accompanying drawings, the content of which is as follows.

### BRIEF DESCRIPTION OF THE ACCOMPANYING DRAWINGS

FIG. 1 shown an electrochemical cell for use in the invention;

FIG. 2 shows a schematic design for a supercapacitor according to the invention;

FIG. 3 shows graphs of the results of measurements taken in Example 7 showing the relation between the low frequency capacitance of the carbon nanotube-polypyrrole composite film of the example and the total electric charges passed during electrolytic polymerisation; and

FIG. 4 is a transmission electron microscope image showing the structure of a composite formed in Example 8.

### DETAILED DESCRIPTION OF THE ILLUSTRATED EMBODIMENTS

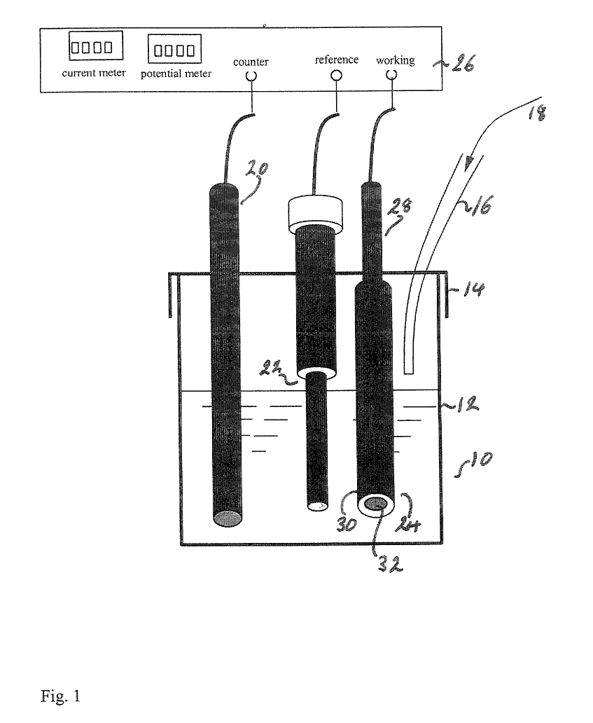

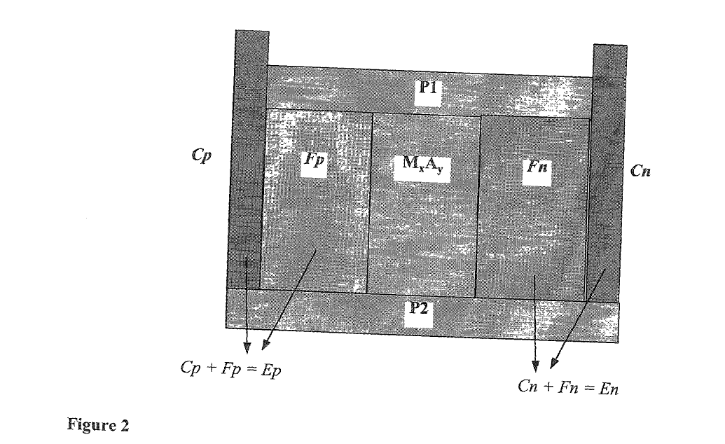

The cell shown in FIG. 1 is described in detail in Example 1. The supercapacitor shown in FIG. 2 uses carbon nanotube/conducting polymer composites as the electrode materials. In this diagram, Ep is the positive electrode (similar to that in a secondary battery) and En is the negative electrode of the supercapacitor. The two flat electrodes are separated by a solid, soft-solid or liquid dielectric medium containing an electrolyte, MₓA_{y}, which can dissociate into M^{y+} cations and A^{x-} anions in the dielectric medium. Ep is composed of the current collector, Cp, and the carbon nanotube/conducting polymer composite film, Fp, which has a positive redox potential. This means that the composite film, Fp, is in the oxidised state when charged and in the neutral state when discharged. Similarly, En is composed of the current collector, Cn, and another carbon nanotube/conducting polymer composite film, Fn. The composite film on the negative electrode, Pn, has a negative redox potential, which means that it is reduced when in the charged state and neutral when in the discharged state. These components are then enclosed in between two insulator plates P1 and P2. An extension of this prototype capacitor is that when all the layers are made sufficiently thin, the capacitor can be rolled together with an insulating spacer into a cylindrical shape to save space.

In this capacitor, the behaviour of ions in the composite film is dependent on whether the carbon nanotubes are neutral or negatively charged. Let us assure in this case that Fp is composed of negatively charged carbon nanotubes and polypyrrole, and Fn is composed of neutral carbon nanotubes and poly(3 -methylthiophene). When this capacitor is discharged, both Fp and Fn are in the neutral state, but Fp contains small cations, M^{x+}, to balance the negative charges on the nanotubes. During charging, electrons are removed from the polymer phase of Fp and, to maintain neutrality, the small cations, M^{x+}, are expelled into the electrolyte. The electrons from Fp are injected into Fn via the external circuit, which is accompanied by the intercalation of cations from the electrolyte, M^{x+}, into Fn. The opposite process occurs during capacitor discharge.

Another example is that when Fp is composed of neutral nanotubes and polypyrrole, and Fn is composed of neutral nanotubes and poly(3-methylthiophene). When this capacitor is discharged, both Fp and Fn are in the neutral state. During charging, electrons are removed from the polymer phase of Fp and, to maintain neutrality, small anions from the electrolyte, A^{y-}, are intercalated into Fp. The electrons from Fp are injected into Fn via the external circuit, accompanied by the intercalation of small cations from the electrolyte. M^{x+}, into Fn. The opposite processes occur during discharge of the capacitor.

### EXAMPLES

### Example 1

### Surface Modified Carbon Nanotubes

The methodology employed in this example is to grow a conducting polymer film on an electrode surface using ionised (anionic) carbon nanotubes as the dopant.

The anionic carbon nanotubes were prepared via surface modification using the literature method (Esumi et al). Carbonaceous materials containing 10-50 wt % carbon nanotubes were dispersed into water via a partial oxidation process in which the carbon nanotubes were refluxed with mixed HNO₃ (50-70%) and H₂SO₄ (90˜100%) for 0.5-1 hours, followed by washing and re-concentration by filtration. This process resulted in the formation of some acidic groups such as carboxyl on the surface of individual carbon nanotubes. These surface groups dissociate in an aqueous solution when its pH is close or higher than the pKₐ values (4-7) of the surface groups, leaving negative charges on the surface of the carbon nanotubes. The negative surface charges result in a repulsive force between individual nanotubes and the formation of a stable suspension containing typically between 0.1 and 0.9 wt % of carbon nanotubes, depending on the type and quality of the carbon nanotubes. The suspensions were found to tolerate a weak electrolyte concentration (about 10⁻³ M or lower) and a change in pH from 3 to 7. They could be diluted readily but drying caused irreversible solidification.

Pyrrole was chosen as a suitable monomer because it can be polymerized under the neutral aqueous conditions in which the carbon nanotube suspensions were stable. The concentration of carbon nanotubes (0.001-0.5 wt. %) in the electrochemical solution was adjusted by dilution with the pyrrole solution (0.01-0.5M). No additional supporting electrolyte was used in order to avoid the involvement of any dopant other than the ionised carbon nanotubes. For the electrochemical experiments, a simple three-electrode and one apartment cell was used in an ambient environment. Argon was used to remove air from and protect the electrochemical solution. Gold, platinum, titanium, copper, vitreous carbon and more frequently, graphite, were used in various shapes as the working electrode. A graphite rod (6.0 mm diameter) and a saturated calomel electrode were used as the counter and reference electrodes, respectively. FIG. 1 schematically shows the electrochemical set up. As shown there, the cell 10 takes the form of a glass beaker 12 with a plastics lid 14 having a first aperture receiving a tube 16 from an argon gas supply 18. Three electrodes pass through the lid 14. These are the graphite rod counter electrode 20, the reference electrode 22 which was a saturated calomel electrode and the working electrode 24. A constant voltage is established between the working electrode and the reference electrode by application of a suitable voltage between the working electrode and the counter electrode via potentiostat control circuitry of conventional nature shown schematically at 26. Circuitry 26 is switchable to operate in constant current mode. The working electrode took the form of a conductive rod 28 covered in an epoxy insulation sheath 30 leaving a circular end face of the rod 28 exposed on which was fixed a disc of working electrode material 32.

Electropolymerisation was carried out using either constant or cyclic potential, or constant current electrolysis with the monomer oxidation potential being set between 0.7 V and 1.0 V against the saturated calomel electrodes. As indicated by an increase in current with electrolysis time and by the formation of a black coating, the polymerization occurred when the pyrrole concentration was relatively high, 0.1-0.5 M. This result suggested that the carbon nanotube suspension acted as a weak supporting electrolyte. Furthermore, an increase in carbon nanotubes concentration accelerated the growth of the polymer coating, demonstrating that carbon nanotubes indeed participated in the electrolysis. As in the case of simple conducting polymers, the composite coating grew faster when the oxidation potential was increased. No coating was observed during electrolysis of a carbon nanotube suspension in the absence of pyrrole.

After the film was rinsed in water and dried in a vacuum box at room temperature, it was inspected using optical and high resolution SEM (scanning electron microscopy). This approach confirmed the presence of carbon nanotubes within the films and demonstrated the formation of dense or porous composite films depending on the nature of the starting materials and the conditions for electropolymerisation. In addition, the microscopy of the composite films did not show a clear relation, except in extreme cases, between the concentration of carbon nanotubes in the electrochemical solution and that in the resulting composite film. This observation is actually in accordance with the dopant role of the anionic carbon nanotubes, i.e. their concentration in the film is determined by the total positive charge on the polypyrrole chains. However, we also believe that a proportion of the carbon nanotubes in the film were entrapped physically.

Nevertheless, there are some microscopic features that are worthy of mention. Firstly, there was no significant alignment of carbon nanotubes within the film, but there were areas with localised enrichment of carbon nanotubes relative to the nanotube-to-particle ratio in the original carbonaceous material. Secondly, careful inspections of the thickness and surface texture of the nanotubes suggested that there must be a polymer coating on the surface of each nanotube. In addition, many neighbouring carbon nanotubes were joined together by conducting polymer at a variety of angles. Finally, while all individual nanotubes were coated by the polymer in dense films whose formation was more likely when straight and short nanotubes were used, uncoated nanotubes, often long and/or curved nanotubes, were often observed to be joint together by nanosized polymer domains in porous films.

The coating on the nanotubes in the composite films was too thick (>100 nm) to be inspected by TEM (transmission electron microscopy). Therefore, by electrolysis at a low potential for a short time, a tiny amount of the composite was grown on a bare copper grid, which was suspended on a platinum wire. Upon TEM imaging, nanotubes were observed both enclosed in and protruding from the edges of the bulk composite film. On these protruding nanotubes, an amorphous coating was observed that was much thicker and more uniform than the disturbance (<1 nm) on the outer surface of carbon nanotubes examined after oxidation. This coating can only be attributed to a remarkably uniform layer of polypyrrole. Because the coating observed in these shorter, low potential experiments is much thinner (5-10 nm) than that seen in the earlier experiments (50 nm), there is an implication that the thickness of the coating could be controllable. The protruding nanotubes were joined to other nanotubes by means of the polymer.

### Example 2

### Carbon Nanotubes Without Surface Modifications

The methodology employed in this example is to grow a composite film of conducting polymer and untreated carbon nanotubes. An additional electrolyte is used to conduct current and also provide dopant for electropolymerisation.

Carbon nanotubes without surface modifications were suspended in an organic solvent (such as acetone or acetonitrile) containing a supporting electrolyte (such as 0.1-0.5 M LiClO₄ or Bu₄NPF₆) and a monomer (such as 0.1-0.5 M pyrrole, thiophene or aniline). The content of carbon nanotubes in the suspension was between 0.01 and 1 wt %. The suspension was formed by simply dispersing the nanotubes in the solvent with the aid of shaking, stirring or ultrasonication. Depending on the history of the nanotubes, the formed suspension was on occasion statically stable for a sufficiently long time to allowing further work to be done with the suspension. In other cases, a dynamic suspension was maintained by continuous ultrasonication. Electropolymerisation was then carried out by either constant potential, cycled potential or constant current electrolysis in the same manner as described in Example 1, except chat, instead of the saturated calomel electrode, a silver wire (1.0 mm diameter) was used as a pseudo-reference electrode. After electrolysis, a coating was observed on the surface of the graphite disc electrode. Once washed and dried, the coating was investigated by high resolution scanning electron microscopy, confirming the presence of carbon nanotubes in the coating. The arrangement of the carbon nanotubes in the composite film was very similar to that described in Example 1, i.e. they were randomly packed, although in some areas relatively large agglomerates of carbon nanotubes were observed. Obviously, these agglomerates were due to the incomplete dispersion of the carbon nanotubes in the solution. It is interesting to note that the individual carbon nanotubes in these agglomerates were also uniformly coated with the polymer. Unlike those coatings containing negatively charged nanotubes and formed in an aqueous suspension (see Example 1), the content of the uncharged nanotubes in the coatings formed by this method should be much more dependent on the content of the nanotubes in the suspension used for electropolymerisation. In some cases, an ordered orientation or the nanotube in the film was also observed.

### Example 3

### Gels of Carbon Nanotubes and Polymer

A pyrrole and carbon nanotube suspension as described in Example 1 was allowed to stand in a small beaker in a sealed plastic bag for a few weeks. It was then observed that the solution had gelled. High-resolution SEM and TEM examinations of small amounts of these gels indicated the presence of polymeric material between the nanotubes, which almost certainly acted as a cross-linking agent.

### Example 4

### Preparation of Composite Films of Carbon Nanotubes and Polypyrrole

Carbon nanotubes were dispersed in water via a partial oxidation process in which the carbon nanotubes were refluxed with mixed HNO₃ (50-70%) and H₂SO₄ (90-100%) for 0.5-1 hours, followed by washing and re-concentration by filtration. This process resulted in the formation of some acidic groups such as carboxyl on the surface of individual carbon nanotubes. These surface groups dissociated in slightly acidic (pH 4-7) aqueous solutions, leaving negative charges on the surface of the carbon nanotubes. The negative surface charges resulted in a repulsive force between individual nanotubes and the formation of a stable suspension containing typically between 0.1 and 0.8 wt % of carbon nanotubes depending on the type and quality of the carbon nanotubes.

This carbon nanotube suspension was mixed with pyrrole to give final solutions of 0.01-0.5% carbon nanotube and 0.1-0.5 M pyrrole (C₄H₅N). After deaerating with argon, electropolymerisation was carried out directly in the solution in a simple three-electrode one-apartment cell at constant potential (0.6-0.8 V vs. SCE) or constant current (1.5-3 mA cm⁻²). The working and counter electrodes consisted of a graphite disk and graphite rod, respectively, both having an outer diameter of 6 mm. Once formed, the coated working electrode was rinsed in water.

During polymerisation, the carbon nanotubes functioned firstly as anions for conducting current in the electrolyte and secondly as an anionic dopant for the polymer. In this way, the carbon nanotubes are attracted to the film growing on the working electrode, whereupon they are bound into it by the forming polymer.

### Example 5

### Preparation of Composite Films of Carbon Nanotubes and Poly (3-methylthiophene)

Electrolytic polymerisation of the composite films was carried out in a single compartment electrochemical cell using a standard three-electrode configuration. The electrolyte consisted of an organic solution of 3-methylthiophene, suspended carbon nanotubes and LiClO₄ typically in concentrations of 0.1 M, 0.04 wt % and 0.5 M, respectively. The organic solvent used was generally acetonitrile. Polymerisation was performed in a reaction vessel that was purged with anhydrous argon to exclude water and oxygen from the reaction. The entire reaction vessel was submersed in an ultrasonic bath and sonication was applied for up to 30 minutes before polymerisation in order to suspend the carbon nanotubes in the organic solvent. During sonication, anhydrous argon gas was simultaneously bubbled through the solution.

Electrochemical synthesis was performed galvano-statically, again using a graphite disc working electrode and a graphite rod counter electrode both having an outer diameter of 6 mm. The applied current was typically 1.7 mA with the potential being measured using a silver reference electrode.

### Example 6

### Capacitance Measurement

Composite films of carbon nanotubes and conducting polymers were prepared on the surfaces of graphite or gold electrode, either by simultaneous deposition of nanotubes and conducting polymer(s) from a suspension of nanotubes containing suitable monomer(s) with or without electrolyte(s), as described above, or by deposition of conducting polymers on to a thin layer (up to 100 μm thickness) of aligned carbon nanotubes which was adhered to the surface of electrode via a silver paint. The coated electrodes were transferred to a deaerated electrolyte, such as aqueous 0.5 M potassium chloride solution or 0.5 M LiClO₄ in acetonitrile, for determination of capacitance. It was found that the low frequency capacitance, measured by an ac impedance frequency analyser, of the carbon nanotube/polypyrrole films and carbon nanotube/poly(3-methylthiophene) films reached values as high as 585 mF cm⁻² and 300 mF cm⁻², respectively.

### Example 7

### Relation Between Film Thickness and Low Frequency Capacitance

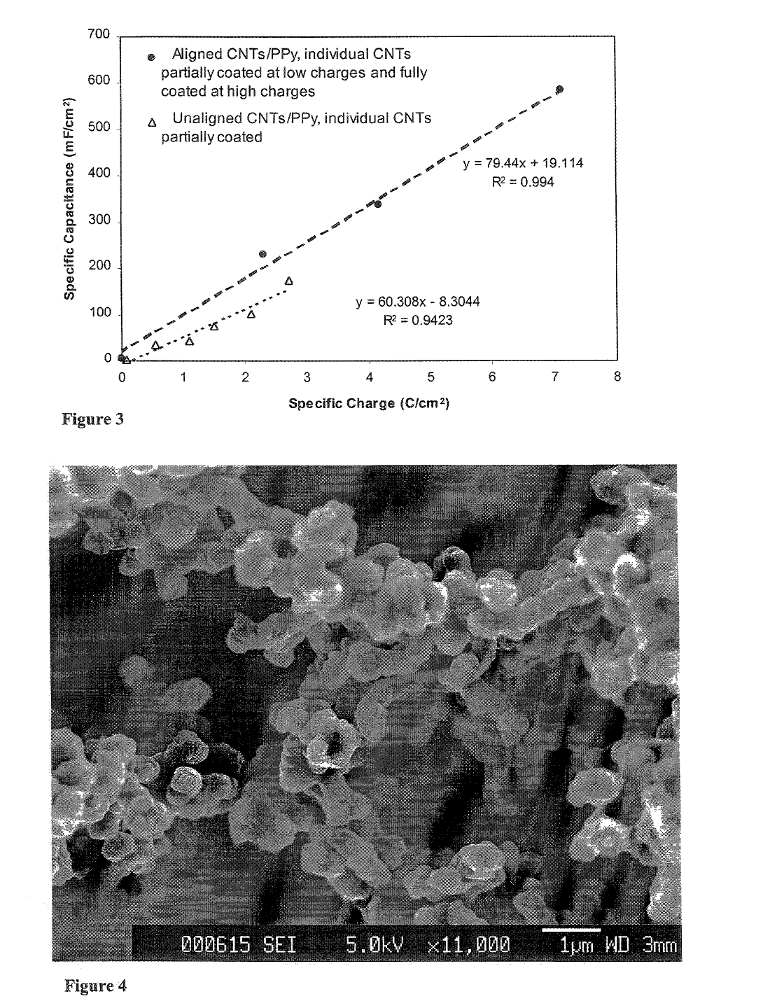

Carbon nanotube/conducting polymer composite films of different thickness were prepared by varying the total charge passed during electrolytic polymerization. The capacitance of these films were then measured and plotted against the total electrolysis charge, as shown in FIG. 3. Because the total electrolysis charge is proportional to the total amount of polymer formed, and the electrode used had the same surface area, the thickness of the formed films is considered proportional to the total electrolysis charge.

### Example 8

### Microstructure of Films Produced Above

The films were dried at room temperature and inspected by high resolution scanning electron microscopy. It was found that the carbon nanotubes were randomly packed in such a manner that open pores were formed in the film. In addition, the polymer was found to exist in the composite in two different forms (FIG. 4). The first occurrence of the polymer was as a uniform coating (up to 500 nm in thickness) on each individual carbon nanotube. The second occurrence was in nanometer-sized domains forming webbing between coated carbon nanotubes. This unique morphology is highly beneficial to capacitor applications because the electron conduction and ion transport in the film can be greatly accelerated. Electron conduction is enhanced by the carbon nanotubes, disregarding the redox state of the polymer (conducting polymers are poor conductors when they are in a neutral redox state). Ion transport in the film is improved firstly by the electrolyte contained in the open pores, and secondly the small transport distance in the nanometer sized polymer phase. Furthermore, these interconnected pores allow thick tilts to be grown without losing accessible capacitance.

### Example 9

### Charging and Discharging Mechanism

Cyclic voltammetry was used to compare the charging and discharging behaviour of the negatively charged carbon nanotube/conducting polymer composite films to that of the pure conducting polymer prepared using similar conditions and containing about the same amount of polymer. There are two significant differences between the obtained cyclic voltammograms (CVS). Firstly, the currents on the CVS of the composite film were up to three times larger than those of the pure conducting polymer films. Secondly, the redox waves in the case of the polypyrrole/carbon nanotube composite films were located at potentials about 200-300 mV more negative than those of the pure polymer films.

The greater current output of the composite films indicates a greater degree of charging and discharging, apparently derived from the conductive contribution of the carbon nanotubes in addition to the unique morphology of the composite films as revealed by SEM. The occurrence of the redox waves at more negative potentials for the carbon nanotube/polypyrrole composite films is an expected contribution mainly from the negatively charged acid-treated carbon nanotubes which make it easier to remove electrons from the film (oxidation) and more difficult to add electrons (reduction). In addition, the conductive contributions of carbon nanotubes combined with the porous structure of the composite films reduce the polarisation charges in the solid (electrons) and liquid (ions) phases.

It should be pointed out that the presence of negatively charged carbon nanotubes in nanotube/polypyrrole composite films makes ionic transport different to that of pure polypyrrol films during charging and discharging. For pure polypyrrole films, oxidation leads to the formation of a positive charge on the polymer chains and is therefore accompanied by the intercalation of anions from the electrolyte. The anions are removed from the film during discharging (reduction). However, in the case of the carbon nanotube/polypyrrole composite films, the negatively charged nanotubes are physically entrapped in the film and therefore cannot be removed during discharging. To maintain neutrality, cations from the electrolyte must intercalate into the film during discharging when the positive charge on the polymer chains is removed. If the composite film is formed under such a condition that both negatively charged nanotubes and small anions take part in the electropolymerisation, discharging the composite films can lead to not only the intercalation of cations into but also the removal of anions from the film.

In a modification of the exemplified methods, the aqueous suspension of the acid treated CNTs as described above in Example 1 can undergo solvent exchange with an organic solvent such an acetone or acetonitrile, producing a stable organic CNT suspension. Suitable amounts of monomer(s) and supporting electrolyte can then be added to this organic suspension of CNTs enabling CNT-ECP composites to be produced from organic suspensions using the methods described in Examples 1 and 2 without the need for mechanical stirring or ultrasonication.

As shown by the above examples, we have established that a uniform coating of all nanotubes in the film, including those concealed inside the film, can be obtained by depositing the carbon nanotubes at the same time as the redox material (conducting polymer). This has been achieved in the case of electrolytically produced polypyrrole by dispersing carbon nanotubes in the polymerisation electrolyte. Each carbon nanotube is coated by a very thin layer of polymer. However, significantly thicker layers of composite can be produced whilst still ensuring each nanotube is coated.

Further, we have electrochemically combined carbon nanotubes with conducting polymers, such as polypyrrole and poly(3-methylthiophene), to form a composite in which individual carbon nanotubes are coated by a thin layer of polymer (up to 500 nm thickness) and packed randomly, or with some preferred orientations or aligned generating a structure with nano to micrometer-sized pores. When applied in supercapacitors, low frequency capacitance values as high as 585 mF cm⁻² were achieved, which is significantly larger than that attained by other supercapacitors based on carbon or polymer alone. It is expected that with further improvement in experimental conditions, selection of materials for both preparation of the composite film and use in the supercapacitor, and optimisation of the structure of the device, values of the low frequency capacitance greater than the threshold of 1 F cm⁻² can be achieved. The excellent performance of these devices is related to the structure of the composite films, which makes use of the large exposed surface area of the carbon nanotubes and the excellent pseudo-capacitive response of the conducting polymer coating on each nanotube. For this reason, the use of long and/or curved carbon nanotubes promotes a more porous structure that favours capacitor applications.

All documents referred to herein are hereby incorporated by reference as if written out here in their entirety.

References

Fan et al: Synthetic Metals, 102 (1999) -1266.

Downs, C., Nugent, J., Ajayan, P. M., Duquette, D. J., Santhanam, S. V., Efficient polymerization of aniline at carbon nanotube electrodes, ADVANCED MATERIALS, 1999, Vol. 11, No. 12, pp. 1028-1031.

Huggins, R. A., Supercapacitors, PHILOSOPHICAL TRANSACTIONS OF THE ROYAL SOCIETY OF LONDON SERIES A-MATHMATICAL PHYSICAL AND ENGINEERING SCIENCES, 1996, Vol.354, No-1712, pp.1555-1566.

Fricke, J., Emmerling, A., Aerogels—Recent progress in production techniques and novel applications, JOURNAL OF SOLGEL SCIENCE AND TECHNOLOGY, 1998, Vol.13, No.1-3, pp.299-303.

Faggioli, E., Rena, P., Danel. V., Andrieu, X., Mallant. R., Kahlen, H., Supercapacitors for the energy managemnent of electric vehicles, JOURNAL OF POWER SOURCES, 1999, Vol. 84, No. 2, pp.261-269.

Mayer, S. T., Pekala, R. W., Kaschmitter, J. L., The Aerocapacitcr—An Eletrochemical Double-Layer Energy-Storage Device, JOURNAL OF THE ELECTROCHEMICAL SOCIETY, 1993, Vol. 140, No. 2, pp. 446-451.

Conway, B., (1) Origin and significance of redox supercapacitance, and its manifestation at various inorganic materials, PROCEEDINGS OF THE SYMPOSIUM ON NEW SEALED RECHAGEABLE BATTERIES AND SUPERCAPACITORS, (ed. Barnett, B.), The Electrochemical Society, 1993, p. 15.

Conway, B., (2) Transition from ‘supercapacitor’ to ‘battery’ behaviour in electrochemical energy storage, JOURNAL OF THE ELECTROCHEMICAL SOCIETY, 1991, Vol. 13B, p. 1539.

Liu, C. Y., Bard, A. J., Wudl, F., Weitz, I., Heath, J. R., Electrochemical characterization of films of single-walled carbon nanotubes and their possible application in supercapacitors, ELECTROCHEMICAL AND SOLID STATE LETTERS, 1999, Vol. 2, No. 11, pp. 571-578.

Kalaji, M., Murphy, P. J. Williams, G. O., The study of conducting polymers for use as redox supercapacitors, SYNTHETIC METALS, 1999, Vol. 102, No. 1-3, pp. 1260-1361.

Long, J. W., Swider, K. B., Merzbacher, C. I., Rolison, D. R., Voltammetric characterization of ruthenium oxide-based aerogels and other RUO2 solids: The nature of capacitance in nanostructured materials, LANGMUIR, 1999, Vol. 15, No. 3, pp. 780-785.

Sarangapani, S., Tilak, B. V, Chan, C. P., Materials for electrochemical capacitors—Theoretical and experimental constraints, JOURNAL OF THE ELECTROCHEMICAL SOCIETY, 1996, vol. 143, No. 11, pp. 2791-3799.

Zheng, J. P., Jow, T. R., A new charge storage mechanism for electrochemical capacitors, JOURNAL OF THE ELECTROCHEMICAL SOCIETY, 1995, Vol. 142, No. 1, pp. L6-L8.

Sawai, K., Ohzuku, T., A method of impedance spectroscopy for predicting the dynamic behavior of electrochemical system and its application to a high-area carbon electrode, JOURNAL OF THE ELECTROCHEMICAL SOCIETY, 1997, vol. 144, No. 3, pp. 988-995.

Niu, C. M., Sichel, E. K., Hoch, A., Moy, D., Tennent, H., High power electrochemical capacitors based on carbon nanotube electrodes, APPLIED PHYSICS LETTERS, 1997, Vol. 70, No. 11, pp. 1480-1482.

Fusalba, F., Belanger, D., Electropolymerization of polypyrrole and polyaniline-polypyrrole from organic acidic medium, JOURNAL OF PHYSICAL CHEMISTRY B. 1999, vol. 103, No. 42, pp. 9044-9054

Carlberg, J. C., Inganas, O., Poly(3,4-ethylenedioxythiophene) as electrode material in electrochemical capacitors, JOURNAL OF THE ELECTROCHEMICAL SOCIETY, 1997, Vol.144, No. 4, pp. L61-L64.

Cimino, A., and Carra, S., Electrodes of Conductive Metallic Oxides—Part A, (Ed. Trasatti, S.), Elsevier New York, 1980, p. 97.

Otero, T. P., Cantero, I., Statistical design to optimize specific charges in polypyrrole by electrosynthesis, JOURNAL OF THE ELECTROCHEMICAL SOCIETY, 1999, Vol. 146, No. 11, pp. 4118-4123.

Curran, S. A., Ajayan, P. M., Blau, W. J., Carroll, D. L., Coleman, J. N., Dalton, A. B., Davey, A. P., Drury, A., McCarthy, B., Maier, S., Strevens, A., A composite from poly(M-phenylenevinylene-co-2,5-dioctoxy-P-phenylene-vinylene) and carbon nanotubes: A novel material for molecular optoelectronics, ADVANCED MATERIALS, 1998, Vol. 10, No. 14, p. 1091-1094.

Fan, J. H., Wan, M. X., Zhu, D. B., Chang, B. H., Pan, Z. W., Xe, S. S., Synthesis, characterizations, and physical properties of carbon nanotubes coated by conducting polypyrrole, JOURNAL OF APPLIED POLYMER SCIENCE, 1999, Vol. 74, No. 11, pp. 2605-2610.

Yoshino, K.. Kajii, H., Araki, H., Sonoda, T., Take, H., Lee, S., Electrical and optical properties of conducting polymer-fullerene and conducting polymer-carbon nanotube composites, FULLERENE SCIENCE AND TECHNOLOGY, 1999, Vol. 7, No. 4, pp. 695-711.

Chen, G., Shaffer, M., Coleby, D., Dixon, C., Zhou, W., Fray, D., Windle, A., Carbon Nanotube and Polypyrrole Composites; Coating and Doping, ADVANCED MATERIALS, 2000, Vol. 12, No. 7, pp. 522 -526.

Esumi, K., Ishigami, M., Nakajima, A., Sawada, K., Honda, H.. Chemical treatment of carbon nanotubes, CARBON, 1996, Vol. 34, No. 2, pp. 279-281.

Naci, K., Suematsu, S., Manago, A., Electrochemistry of Poly(1,5-diaminoanthraquinone) and its Application in Electrochemical Capacitor Materials. Journal of the Electrochemical Society 147(2), 420-426, 2000.

Audebert, P., Catel, J- M., Le Coustumer, G., Duchenet, V. and Hapiot, P., Electrochemistry and Polymerization Mechanisms of Thiophene—Pyrrole—Thiophene Oligomers and Terthiophenes. Experimental and Theoretical Modeling Studies, J. Phys. Chem. B 1998 102, 8661-8669.

Schweiger, L. F., Ryder, K. S., Morris, D. G. Glidle, A., Cooper, J. M. Strategies towards functionalised electronically conducting organic copolymers. J. Mater. Chem., 2000, 10, 107-114.

Ryder, K. S., Schweiger, L. P., Glidle, A., Cooper, J. M., Strategies towards functionalised electronically conducting organic copolymers: Part 2 Copolymerisation, J. Mater. Chem. 2000, 10, 1785-1793.

1. A method for the production of an electronically conducting polymer composite material, comprising:
preparing a dispersion of carbon nanotubes in a solution of one or more polymerisable monomers which upon polymerisation form an electronically conducting polymer; and polymerising the monomer solution to form a unitary polymer mass containing said nanotubes dispersed therein.

2. A method as claimed in claim 1, wherein the one or more polymerisable monomers are selected from aniline, benzene, furan, pyrrole, thiophene and their derivatives.

3. A method as claimed in claim 1, wherein the one or more polymerisable monomers are present in the solution at a concentration of 0.1-0.5 M.

4. A method as claimed in claim 1, wherein the carbon nanotubes are present in the dispersion in an amount of 0.001-1 wt %.

5. A method as claimed in claim 1, wherein negatively ionised carbon nanotubes are used.

6. A method as claimed in claim 5, wherein the solvent comprises one or more of water, acetone, acetonitrile, toluene, methanol, ethanol, dichloromethane, dimethyl-formamide, dimethylsulfoxide, tetrahydrofuran, propylene carbonate, an ionic liquid or the or a said polymerisable monomer.

7. A method as claimed in claim 1, wherein non-ionized carbon nanotubes are used.

8. A method as claimed in claim 7, wherein a charge carrier is dissolved in the solvent.

9. A method as claimed in claim 8, wherein the charge carrier comprises one or more salts of formula XₐX_{b}, wherein:
M is selected from H, Li, Na, K, Mg, Ca, Sr, Ba, Cu, Ag, Zn, Fe, Al, tetraalkylammonium; and
X is selected from chloride, bromide, iodide, nitrate, phosphate, sulphate, perchlorate, tetrafluoroborate;
biological anions, organicanions, organic polymer anions, or non-stoichiometric anions and
a and b are charge balancing numbers.

10. A method as claimed in claim 9, wherein the charge carrier salt is present at a concentration of 0.1-0.5 M.

11. A method as claimed in claim 8, wherein the charge carrier comprises a salt and an ionophore.

12. A method as claimed in claim 8, wherein the charge carrier comprises one or more charged biomolecules.

13. A method are claimed in claim 12, wherein the one or more charged biomolecules are selected from amino acids and proteins.

14. A method as claimed in claim 1, wherein the polymerisation is conducted as an electropolymerisation.

15. A method as claimed in claim 14, wherein electropolymerisation is conducted at a monomer oxidation potential of 0.7-1.0 V compared with a saturated calomel electrode.

16. A method as claimed in claim 1, wherein the polymerisation is carried out by allowing said suspension to stand until a gel forms.

17. An electronically conducting polymer/carbon nanotube composite produced by preparing a dispersion of carbon nanotubes in a solution of one or more polymerisable monomers which upon polymerisation form an electronically conducting polymer;
and polymerising the monomer solution to form a unitary polymer mass containing said nanotubes dispersed therein.

18. An electrical energy storage device, comprising;
a first electrode consisting of a first composite of carbon nanotubes and a first electronically conducting polymer and a first conducting member in contact with the first composite;
a second electrode; and
an electrolyte comprising mobile cations and anions, the electrolyte separating the first and second electrodes and being in contact with the first composite.

19. An electrical energy storage device as claimed in claim 18, wherein the second electrode consists of a second composite of carbon nanotubes and a second electronically conducting polymer and a second conducting member in contact with the second composite;
and the electrolyte is in contact with the second composite.

20. An electrical energy storage device as claimed in claim 18, where the electronically conducting polymer or polymers are selected independently from polymers or copolymers of aniline, benzene, furan, pyrrole, thiophene and their derivatives.

21. An electrical energy storage device as claimed in claim 18, wherein the carbon nanotubes are non-ionised.

22. An electrical energy storage device as claimed in claim 18, wherein negatively ionised carbon nanotubes are used.

23. An electrical energy storage device as claimed in claim 19, wherein the first and second composites are in the form of thin films on the first and second conducting members respectively.

24. An electrical energy storage device as claimed in claim 18, rolled into a cylindrical shape with an insulating spacer between the first and second conducting members to form a secondary battery or supercapacitor.

25. An electrical energy storage device, comprising;
a first electrode consisting of a first electrode consisting of a first composite of carbon nanotubes and a first electronically conducting polymer, and a first conducting member in contact with the first composite;
a second electrode; and
an electrolyte comprising mobile cations and anions, the electrolyte separating the first and second electrodes and being in contact with the first composite,
wherein the first electronically conducting polymer has been formed by preparing a dispersion of carbon nanotubes in a solution of one or more polymerisable monomers which upon polymerisation form an electronically conducting polymer; and polymerizing the monomer solution to form a unitary polymer mass containing said nanotubes dispersed therein.

26. An electrical energy storage device comprising;
a first electrode consisting of a first electrode comprising a first composite of carbon nanotubes and a first electronically conducting polymer, and a first conducting member in contact with the first composite;
a second electrode comprising a second composite of carbon nanotubes and a second electronically conducting polymer, and a second conducting member in contact with the second composite; and
an electrolyte comprising mobile cations and anions, the electrolyte separating the first and second electrodes and being in contact with the first composite,
wherein the first and the second electronically conducting polymer has been formed by preparing a dispersion of carbon nano-tubes in a solution of one or more polymerisable monomers which upon polymerisation form an electrically conducting polymer; and polymerising the monomer solution to form a unitary polymer mass containing said nanotubes dispersed therein.
